(19) United States
(12) Patent Application Publication
(10) Pub. No.: US 2018/0125046 A1
(43) Pub. Date: May 10, 2018

(54) WEEDLESS FISHING LURE DEVICE

(71) Applicant: David Coonrod, Levelland, TX (US)

(72) Inventor: David Coonrod, Levelland, TX (US)

(21) Appl. No.: 15/344,297

(22) Filed: Nov. 4, 2016

(51) Int. Cl. A01K 85/02; A01K 85/18

(52) U.S. Cl. CPC A01K 85/02; A01K 85/18

(57) ABSTRACT

A weedless fishing lure device for faster and convenient fishing of a crank bait is disclosed. The weedless fishing lure device has a front hard section comprising a first end and a second end to define a crawfish-like configuration wherein the first end is configured to have a bile area to provide an access for attaching the fishing line to the lure device via one or more eyelets. One eyelet is positioned in the bile area for attaching the fishing line and another eyelet is provided in the middle area for attaching the additional hook for deep water fishing. The second end is configured to have at least one concealed catching member extending from a middle area of the second end of the front hard section. A replaceable rear soft section comprising a nose area is configured to be fixedly attached to the second end of the front hard section via the concealed catching member to use the lure device as a crank bait for fishing.

### BACKGROUND

For ages, people have been fishing using natural baits to lure the predatory fish. It was so natural and evident to use such natural baits to attract the fish, and could trap them using hooks inside a device. However, in these cases, the effectiveness of catching the predatory fish is comparatively low as it needs both manual efforts and patience from the fisher. Following this, artificial lures were introduced to target the predatory fish using different methods and devices. The artificial lures must look natural enough to provide both a visual and natural feel to attract the predatory fish.

Previous attempts have been made to provide a lure device made of hard wood sections with exposed hooks to catch the fish. These devices were used as a crank bait to lure them but these devices do not provide a feel of natural swimming crawfish thru the water. Crawfish are commonly used as a bait to attract the predatory fish, and they do not stop the fish from biting the hook when the claws are removed. However, these devices need to be designed in such a way that it should have a life-like configuration for effectiveness in the fishing. Another common problem is that these devices trap lots of weeds such as vegetation on the hooks which may damage the lure device. Further, the exposed hooks do not allow for easier movement and retrieval of the fish. Sometimes, there is also the use of metal weed guards that are a cumbersome design of the lure device which further adds complexity to the fishing process.

Prior art reference CA 2360518A1 discloses a lure device comprising a hard-body diving lure made from wood or plastic, with an elongated body, having a front end with a diving lip which causes the lure to submerge and wobble back and forth when pulled through the water. But the device does not look like a crayfish and looks to be representing merely a fish swimming through the water. Further, it has an exposed hook set which further reduces the effectiveness of the fishing.

In light of the aforementioned drawbacks and limitations, there exists a need for a lure device to act like a crayfish attracting the predatory fish but without trapping weed from shallow or deep waters.

### SUMMARY

The objective of the present invention is to provide a two stage weedless fishing lure device for faster, efficient and convenient fishing.

According to one embodiment of the present invention, the weedless fishing lure device has a front hard section comprising a first end and a second end to define a crawfish like configuration wherein the first end is configured to have a bile area to provide an access for attaching the fishing line to the lure device via one or more eyelet. The second end is configured to have at least one concealed catching member extending from a middle area of the second end of the front hard section. A replaceable rear soft section comprising a nose area is configured to be fixedly attached to the second end of the front hard section via the concealed catching member to use the lure device as a crank bait for fishing.

According to preferred embodiment of the present invention, the concealed catching member is a hook member extending from the middle area of the second end of the front hard section. The front hard section comprising the bile area and the middle area is made from at least one of a wood, or a hard plastic molded material and the rear soft section is a crawfish section made from a plastic material.

### BRIEF DESCRIPTIONS OF SEVERAL VIEWS OF DRAWINGS

FIG. 1 illustrates a side view of a weedless fishing lure device, according to an embodiment of the present invention.

FIG. 2 illustrates a top view of the weedless fishing lure device, according to the embodiment of the present invention.

FIG. 3 illustrates the side view of a front hard section of the weedless fishing lure device, according to the embodiment of the present invention.

FIG. 4 illustrates the side view of a rear soft section of the weedless fishing lure device, according to the embodiment of the present invention.

### DETAILED DESCRIPTION OF DIFFERENT EMBODIMENTS

The present invention is related to a two stage weedless fishing lure device 100 for faster and convenient fishing.

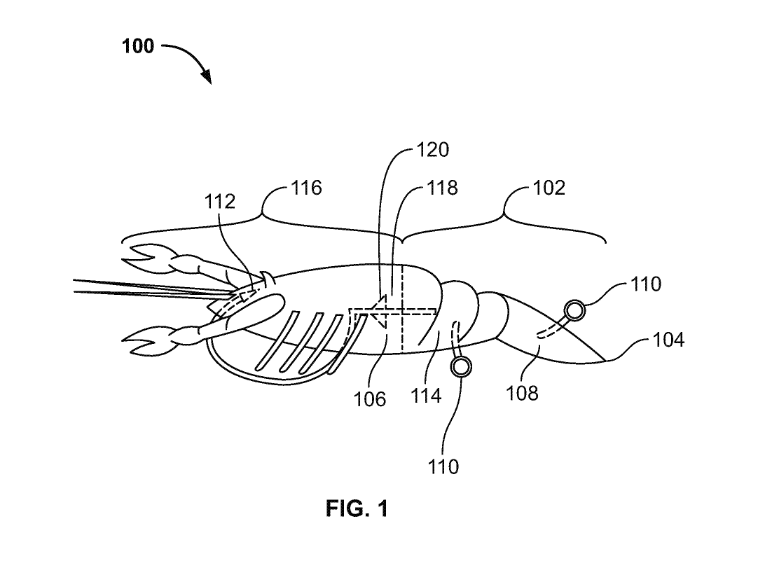

According to an embodiment as shown in FIG. 1, which illustrates a side view of the weedless fishing lure device 100. The weedless fishing lure device 100 has a front hard section 102 comprising a first end 104 and a second end 106 to define a crawfish like configuration wherein the first end 104 is configured to have a bile area 108 to provide an access for attaching the fishing line to the lure device 100 via one or more eyelets 110. One eyelet 110 is positioned in the bile area 108 for attaching the fishing line and another eyelet 110 is provided in the middle area for attaching the additional hook for deep water fishing. The second end 106 is configured to have at least one concealed catching member 112 extending from a middle area 114 of the second end 106 and a replaceable rear soft section or a soft crawfish plastic section 116. The replaceable rear soft section 116 comprising a nose area 118 configured to be releasably engaged to the second end 106 of the front hard section 102 via the concealed catching member 112 to use the lure device 100 as a crank bait for fishing. The front hard section 102 comprising the bile area 108 and the middle area 114 is made from at least one of a wood, or a hard plastic, or a typical molded composite and the rear soft section 116 is a crawfish section made from a plastic material. In another embodiment, the rear soft section 116 is the crawfish section made from floating or non-floating plastic material to enable convenient movement and retrieval of the lure device 100. In exemplary embodiments, other injection modeling material can also be used to make the front hard section of the lure device 100. The weedless fishing lure device 100 looks like a crawfish wherein the bile area 108 represents the tail of the crawfish, middle area 114 which is a hard section represents the flexible part of the tail connecting to the hard skeleton shell body of the crawfish. The nose area 118 which is a soft section provided with moveable legs, antennas, and claws represents the other half of the hard shell and appendages of the leg and claws. This soft configuration enhances the weedless performance of the lure device 100. The configuration of the lure device 100 provides a natural crawfish look to increase the predator to strike the weedless lure device 100. The bile area 108 of the lure device 100 is configured to have typical patterns and shapes to resemble a real flexible tail section. However, it is fixed to provide necessary swimming motion for a crank bait to dive to its maximum designed depth inside the water.

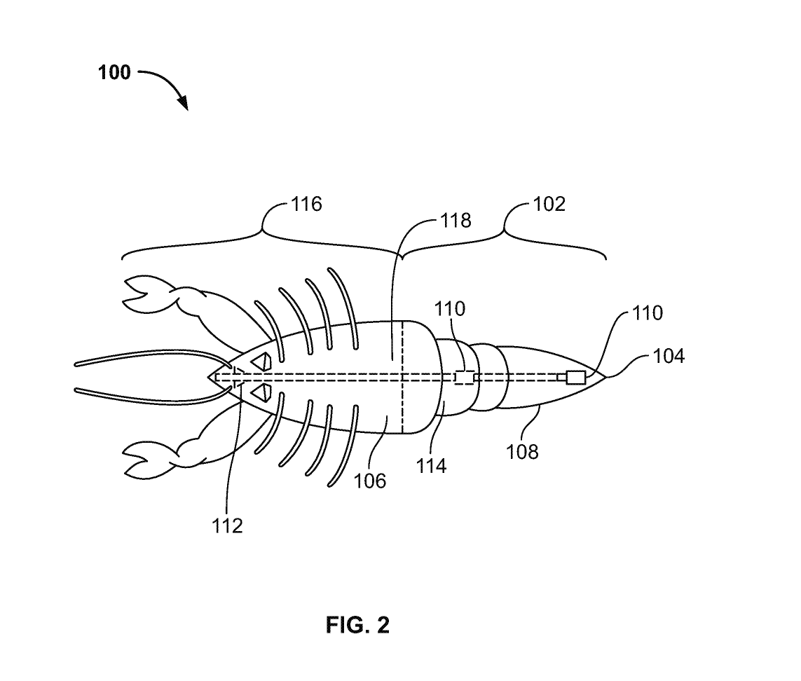

In an embodiment as shown in FIG. 2, which illustrates top view of the weedless fishing lure device 100. The concealed catching member 112 is a hook member extending from the middle area 114 of the second end 106 of the front hard section 102. The hook member 112 extending from the middle area 114 of the second end 106 of the front hard section 102 is configured to securely hold the nose area 118 of the rear soft section 116 to provide weedless fishing using the lure device 100. The hook member 112 is positioned in the second end 106 of the front hard section 102 such that it securely clamps an upper side of the fish's mouth. In a different embodiment as shown in FIG. 1, the concealed catching member 112 comprises a plurality of barb sections 120 positioned on a shaft member of the concealed catching member 112 to securely hold the rear soft section 116 to the front hard section 102. The lure device 100 has a single fixed hook 112 that is designed with an offset to provide the proper alignment and attachment of the rear soft section 116 to the hook member 112. In another embodiment, the single hook member 112 is positioned in the front hard section 102 in such a way it extends to the main eyelet 110 in the bile area 108 of the front hard section 102 as a continuous catching member 112 to provide a stronger lure device 100 and a continuous eyelet 110.

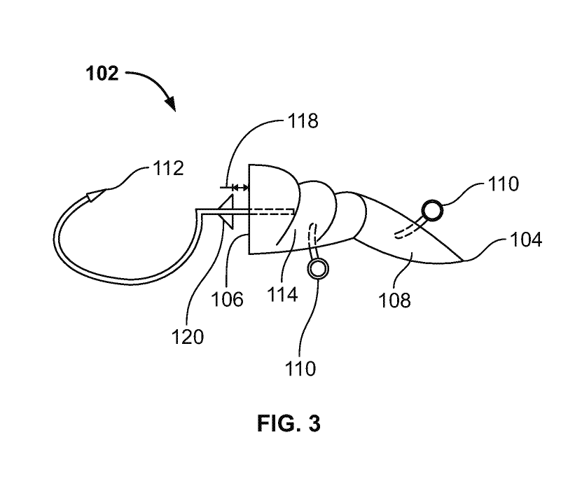

In a preferred embodiment as shown in FIG. 3, the weedless fishing lure device 100 comprises a hard single hook section 112 that looks like the front half of a typical crank bait. The single hook section 112 just extends from the center of the middle area 114 of the front hard section 102 to securely hold the soft crawfish plastic section 116 (shown in FIG. 2) against the front hard section 102. The sharp tip of the single hook section 112 fastens the nose area 118 (shown in FIG. 2) of the soft crawfish section 116 of the lure device 100 to the front hard section 102. This improves the weedless retrieval performance of this lure device 100. Further, this also enables tightened fitting of the soft plastic crawfish section 116 to the front hard section 102.

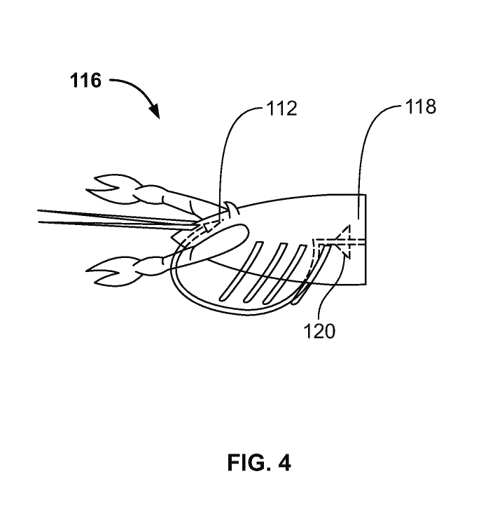

In the another embodiment as shown in FIG. 4, the rear soft section of the weedless fishing lure device 100 is illustrated. The rear soft section 116 receives the sharpened portion of the hard single hook section 112 (shown in FIG. 3) which extends from the middle area 114 (shown in FIG. 3) of the front hard section 102 (shown in FIG. 3) just to secure both the sections together. The rear soft section 116 further comprises the barb sections 120 positioned on a shaft member of the single hook section 112 to securely hold the rear soft section 116 to the front hard section 102 made in a plurality of colors to enhance the aesthetic appearance of the lure device 100. The size and dimensions of this rear soft section 116 is configured to fit any predetermined size of the front hard section 102 of the lure device 100. The front hard section 102 and the rear soft section 116 of the lure device 100 are configured to mimic the crawfish moving through the water. The barbs 120 are positioned on the single hook where it extends from the middle area 114, and when the single hook tip is pushed into the rear soft crawfish section 116, the user makes a twist and forces the hook tip out of the bottom of this rear soft crawfish section 116, and pushes that up against the middle area 114 thereby securing it with those barbs 120. The second and final anchoring point is where the hook tip of the fixed single hook 112 is embedding into the nose area 118 between the claws of the soft crawfish section 116.

In an exemplary embodiment as shown in FIG. 1, the front hard section 102 of the weedless fishing lure device 100 is configured to have 2 inches and the barb section 120 on the shaft of the single hook section 112 extends is positioned at about 2½ inches from the tip of the front hard section 102. The total length of the lure device 100 comprising the front hard section 102 and the rear soft section 116 is about 5½ inches. The length of the rear soft section 116 is about 3½ inches which is made from a warm material such as a floating or non-floating flexible material. The user can also add an additional tribal hook to the second eyelet 110 on the bottom of the lure device 100 to be used for deep water applications. The lure device 100 is designed to swim in a normal backward direction when trying to elude its prey. The floating plastic of the rear soft section 116 gets suspended and works in a natural defensive position with the claws in an upward direction whenever the user slows down or stops reeling in the lure device 100.

The weedless fishing lure device 100, according to the present invention, is configured to travel in a natural escape motion like a typical crawfish which tries to out run its predator. The hard single hook section 112 and its concealed placement provides an efficient approach to lure the fish by acting as the crank bait. This also helps in fighting large fish and also allows for easier removal and releasing of the hooked fish. The floating plastic soft section 116 provides the lure with better movement for slow and fast retrieval. This further eliminates the weed nuisance such as low lying vegetation and other structures getting trapped by the hook section as the hard single hook section 112 is concealed inside the body of the lure device 100. The fish generally bite this lure device 100 which tears up the rear soft section 116 of the lure device 100 and the rear soft section 112 will be usable for a few attempts as it is replaceable and the user can easily change the rear soft section to match any predetermined front hard section 102. The hard single hook section 112 of the lure device 100 is made in three different sizes to fit various requirements of the fishing using this lure device 100 as a crank bait. The position of the hook member 112 allows for safer hooking in the fish's mouth so that it does not injure the fish's gills or eye areas.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

I claim:

1. A weedless fishing lure device comprises:
a front hard section comprising a first end and a second end to define a crawfish-like configuration wherein the first end is configured to have a bile area to provide an access for attaching the fishing line to the lure device via one or more eyelets;
wherein the second end is configured to have at least one concealed catching member extending from a middle area of the second end;
a replaceable rear soft section comprising a nose area is configured to be fixedly attached to the second end of the front hard section via the concealed catching member to use the lure device as a crank bait for fishing.

2. The weedless fishing lure device of claim 1, wherein the concealed catching member is a hook member extending from the middle area of the second end of the front hard section.

3. The weedless fishing lure device of claim 2, wherein the hook member extending from the middle area of the second end of the front hard section is configured to securely hold the nose area of the rear soft section to provide weedless fishing the lure device.

4. The weedless fishing lure device of claim 2, wherein the hook member is positioned in the second end of the front hard section such that it securely hooks the upper side of the fish mouth.

5. The weedless fishing lure device of claim 1, wherein the concealed catching member comprises a plurality of barb sections positioned on a shaft member of the concealed catching member to securely hold the rear soft section to the front hard section.

6. The weedless fishing lure device of claim 1, wherein the front hard section comprising the bile area and the middle is made from at least one of a wood, a hard plastic or a typical molded composite.

7. The weedless fishing lure device of claim 1, wherein the rear soft section is a crawfish section made from a soft plastic material.

8. The weedless fishing lure device of claim 7, wherein the crawfish section is made from floating plastic material to enable convenient movement and retrieval of the lure device.

9. The weedless fishing lure device of claim 1, wherein the front hard section and the rear soft section of the lure device is configured to mimic the crawfish moving through the water.

10. The weedless fishing lure device of claim 1, wherein the size of the rear soft section is configured to fit any predetermined size of the front hard section of the lure device.
